(19) United States
(12) Patent Application Publication
(10) Pub. No.: US 2011/0020718 A1
(43) Pub. Date: Jan. 27, 2011

(54) FUEL CELL ARRANGEMENT

(75) Inventors: Marc Bednarz, Taufkirchen (DE); Stefan Ibrahim Peterhans, Gaissach (DE); Wolfgang Wagner, Neubiberg (DE); Uwe Wurtenberger, Munich (DE)

Correspondence Address: RADER, FISHMAN & GRAUER PLLC, 39533 WOODWARD AVENUE, SUITE 140, BLOOMFIELD HILLS, MI, 48304-0610, US

(73) Assignee: MTU Onsite Energy GmbH

(21) Appl. No.: 12/918,533

(22) PCT Filed: Oct. 28, 2008
(86) PCT No.: PCT/EP2008/009092

§ 371 Date: Aug. 20, 2010

(30) Foreign Application Priority Data
Oct. 29, 2007 (DE) 10 2007 051 514.8

(51) Int. Cl. H01M 8/06

(52) U.S. Cl. 429/423

(57) ABSTRACT

A fuel cell arrangement having fuel cells situated in the form of a fuel cell stack, which each contain an anode and a cathode and an electrolyte matrix situated between them, having an anode intake, which is provided on one side of the fuel cell stack, for the supply of fresh combustion gas to the anodes and an anode outlet for the discharge of consumed combustion gas from the anodes, the combustion gas being guided inside the fuel cells in a predetermined main flow direction past the anodes, having reformer units for converting a fuel supplied to the reformer units at a fuel inlet into reformer fuel, which is discharged from the reformer units at a reformer fuel outlet, the reformer units being situated between adjacent fuel cells in thermal contact therewith, and the reformer fuel outlet of the reformer units opening on the side of the fuel cell stack, on which the anode intake of the fuel cells is located, and having a fuel discharge system for distributing the fuel to be reformed to the individual reformer units. The reformer units have fuel inlets provided on the side of the fuel cell stack opposite to the anode intake and are permeated by the fuel to be reformed in counter-flow to the main flow direction of the combustion gas, and the fuel discharge system is provided on the side of the fuel cell stack opposite to the anode intake.

### CROSS-REFERENCE TO RELATED APPLICATIONS

Application PCT/EP2008/009092 claims priority for Application 10 2007 051 514.8 filed on Oct. 27, 2007 in Germany.

### TECHNICAL FIELD

The invention relates to an improved fuel cell configuration arranged in the form of a fuel cell stack, which each contains an anode and a cathode and an electrolyte matrix situated between them. Each stack has an anode intake, which is provided on one side of the fuel cell stack, for the feed of fresh combustion gas to the anodes and an anode outlet for the discharge of consumed combustion gas from the anodes. Gas flow pathways are provided inside the fuel cells in order to guide the combustion gas in a predetermined main flow direction past the anodes. Each stack also has reformer units for converting a fuel supplied to the reformer units at a reformer fuel outlet. The reformer units are situated between adjacent fuel cells in thermal contact therewith inside the fuel cell stack, and the reformer fuel outlet of the reformer units opens on the side of the fuel cell stack on which the anode intake of the fuel cells is located Each stack also has a fuel discharge system for distributing the fuel to be reformed to the individual reformer units.

### SUMMARY OF THE INVENTION

Typical fuel-cell configurations, in particular those of molten carbonate fuel cells, contain fuel cells situated in the form of a fuel cell stack, which each comprise an anode and a cathode and an electrolyte matrix situated between them, an anode intake, provided on one side of the fuel cell stack, for the feed of fresh combustion gas to the anodes, and an anode outlet for the discharge of consumed combustion gas from the anodes, gas flow pathways being provided within the fuel cells, in order to lead combustion gas past the anodes in a given main flow direction. Reformer units are used for converting a fuel fed to a fuel inlet of the reformer units into reformer fuel or combustion gas, which is discharged from the reformer units at a reformer fuel outlet, the reformer units being situated within the fuel cell stack between adjacent fuel cells in thermal contact therewith, and the reformer fuel outlet of the reformer units opening on the side of the fuel cell stack on which the anode intake of the fuel cells and a fuel discharge system for distributing the fuel to be reformed to the individual reformer units are located. The reformer units are thus used, on the one hand, for generating combustion gas which can be reacted in the fuel cells, produced by reforming the fuel fed to the reformer units, and, on the other hand, for the internal cooling of the fuel cell stack because of the endothermic character of the reaction running in the reformer units, by which heat is withdrawn from the fuel cells because of the thermal contact therewith.

A fuel cell configuration of the type described at the beginning is known from DE 699 10 624 T2, which is based on EP 1 157 437 B1, in which a gas hood for distributing the combustion gas to the anode intakes is provided on the side of the anode intakes of the fuel cells assembled into the fuel cell stack, under which the fuel discharge system is housed, which is used for distributing the fuel to be reformed to the individual reformer units. It comprises a fuel supply distributor pipe, to which the fuel to be reformed can be externally fed via a fuel inlet line pipe, and which is connected via feed lines to each of the individual reformer units. The reformer units are formed by plate-shaped elements, which are situated between the fuel cells and parallel thereto. The reformer units have fuel inlet openings on the same side of the fuel cell stack on which both the anode intakes and also the fuel outlets of the reformer units are also located. The fuel to be reformed, which is fed from the fuel discharge system to the individual reformer units, is therefore guided in the same plane on a U-shaped pathway through the interior of the reformer units from the side of the fuel cell stack on which the anode intake is located, firstly in common flow with the main flow direction of the combustion gas to the anodes and/or in the gas flow pathways leading past the anodes into the reformer units and then guided back in counter-flow thereto. The two opposing flow pathways within the reformer units are separated by a baffle plate in the known fuel cell configuration.

A fuel cell configuration having fuel cells situated in the form of a fuel cell stack is known from DE 102 32 331 B4, which each contain an anode and a cathode and an electrolyte matrix situated between them, in which an anode intake for the feed of fresh combustion gas to the anodes is provided on one side of the fuel cell stack, and which has an anode outlet for the discharge of consumed combustion gas from the anodes, gas flow pathways again being provided inside the fuel cells, in order to lead the combustion gas past the anodes in a given main flow direction. For the feed of fresh cathode gas to the cathodes of the fuel cells, they have a cathode intake, and they have a cathode outlet for the discharge of consumed cathode gas from the cathodes, gas flow pathways being provided inside the fuel cells in order to lead the cathode gas past the cathodes. The gas flow pathways for the cathode gas have parts running partially opposite to the main flow direction thereof, which are situated inside the fuel cells or between adjacent fuel cells, cathode gas having a lower temperature, corresponding to the purpose of cooling the fuel cells, being able to be fed to the parts of the gas flow pathways running opposite to the main flow direction of the cathode gas. In this way, the fed cathode gas performs internal cooling of the fuel cell stack, which causes a reduction of the temperature and thus a higher current density, at which the fuel cells may be operated.

The object of the invention is to provide a fuel cell configuration of the type described at the beginning, in which fuel to be reformed is converted using internal reforming, and is operable at a high current density.

The object may be achieved by a fuel cell configuration having fuel outlets of the reformer units on the side of the fuel stack opposite to the anode intake and the reformer units are permeated by the fuel to be reformed in counter flow to the main flow direction by the combustion gas in the gas flow pathways leading past the anodes, and the fuel discharge system provided for distributing the fuel to be reformed is provided on the side of the fuel cell stack opposite to the anode intake.

Various advantageous embodiments and refinements of the fuel cell configuration according to the invention are also.

In one embodiment, there id disclosed a fuel cell configuration having fuel cells situated in the form of a fuel cell stack, which each contain an anode and a cathode and an electrolyte matrix situated between them, is provided by the invention, having an anode intake provided on one side of the fuel cell stack for the feed of fresh combustion gas to the anodes and an anode outlet for the discharge of consumed combustion gas from the anodes, gas flow pathways being provided inside the fuel cells, in order to lead the combustion gas past the anodes in a predefined main flow direction, having reformer units for converting a fuel fed to the reformer units at a fuel inlet into reformer fuel, which is discharged from the reformer units at a reformer fuel outlet, the reformer units being situated inside the fuel cell stack between adjacent fuel cells in thermal contact therewith, and the reformer fuel outlet of the reformer units opening on the side of the fuel cell stack on which the anode intake of the fuel cells is located, and having a fuel discharge system for distributing the fuel to be reformed to the individual reformer units. It is provided according to the invention that the fuel inlets of the reformer units are provided on the side of the fuel cell stack opposite to the anode intake and the reformer units are permeated by the fuel to be reformed in counter-flow to the main flow direction of the combustion gas in the gas flow pathways leading past the anodes, and the fuel discharge system provided for distributing the fuel to be reformed is provided on the side of the fuel cell stack opposite to the anode intake.

It is a special advantage of the invention that no deflection of the fuel occurs in the plane of the reformer units, as is the case in the prior art. The pressure losses are thus significantly reduced (50%), so that a much higher gas throughput is possible than in the case of fuel cell plants having identical dimensions of the parts. Plants of the current magnitude are thus also operable using biogenic gases, which have a lower calorific value than methane.

Furthermore, it is possible to optimize the cooling in the stack through the flow guiding of the fuel to be reformed in the plane of the reformer units. In the case of guiding of the cathode gas in cross-flow to the fuel, the temperature in the area of the cathode intake is lower than in the area of the cathode outlet. In order to prevent excessively strong cooling by the reforming procedure in the areas adjacent to the cathode intake area, it is easily possible to reduce the fuel flow in the corresponding areas of the reformer units or to avoid it entirely by separating corresponding areas by walls, in that according to the invention corresponding areas (20 to 100% of the maximum possible width) of the overlap of the fuel feeds connected to the reformer units are simply left out. Alternatively or additionally, the positioning of catalyst material is dispensed with in the corresponding areas.

According to an advantageous embodiment of the fuel cell configuration according to the invention, a gas hood, which is used for receiving the consumed combustion gas discharged from the anode outlets, is provided on the side of the fuel cell stack opposite to the anode intakes, where the fuel discharge system is situated.

According to one embodiment of the invention, the gas hood delimits a chamber which receives the consumed combustion gas discharged from the anode outlets, in which fuel feeds, which are each connected to the fuel inlets of one reformer unit, and a distributor line connected to each of the fuel feeds are situated.

The distributor line is advantageously connected to the fuel feeds via particular intermediate lines, which each contain a dielectric partition element for the electrical insulation of the reformer from the distributor line.

According to another advantageous embodiment, it can be provided that the gas hood delimits a chamber which receives consumed combustion gas discharge on the anode outlets, in which fuel feeds, which are each connected to the fuel intakes of each reformer unit, are situated, and the gas hood contains a first gas guiding pathway, which forms a chamber used to receive the consumed combustion gas from the anode outlets, and at least one gas guiding channel, which is sealed thereto and is connected to the fuel feeds, for the discharge of fuel to the fuel feeds.

It can also be advantageously provided that the gas guiding channel or the gas guiding channels are connected to the fuel feeds via intermediate lines in each case, which each contain a dielectric partition element for the electrical insulation of the reformer from the distributor line.

The gas guiding channel can be formed by a hollow profile running on a longitudinal side of the gas hood.

Hollow profiles may also be provided on both longitudinal sides of the gas hood.

The gas hood is expediently implemented as a composite made of plates and crossbeams, in which the hollow profiles are integrated as lateral parts of the gas hood.

One of the hollow profiles is expediently implemented having openings for the discharge of the anode exhaust gas exiting from the anode outlet into the chamber delimited by the gas hood.

For this purpose, the hollow profile is implemented having holes on its inner side, via which the anode exhaust gas enters the hollow profile. The anode exhaust gas is discharged outward via connecting pieces on its outer side.

The reformer units are preferably implemented by plate-shaped elements situated parallel to the fuel cells, which each exclusively define gas flow pathways, which are permeated in counter-flow to the main flow direction of the reformed combustion gas in the gas flow pathways leading past the anodes.

The gas flow pathways defined by the plate-shaped elements may contain a material of a reformer catalyst.

The reformer units may contain bipolar plates, by which adjacent fuel cells of the fuel cell stack are delimited from one another and electrically contacted.

The bipolar plates may delimit the gas flow pathways in the reformer units toward one of the adjacent fuel cells.

Exemplary embodiments of the invention are explained hereafter on the basis of the drawing. In the figures:

### BRIEF DESCRIPTION OF THE DRAWINGS

FIG. 1 shows a schematic perspective partial view of a fuel cell configuration having fuel cells situated in the form of a fuel cell stack to explain the fundamental flow of the gas through the fuel cells;

FIG. 2 shows a schematic view of a fuel cell from the front side of the fuel cell stack shown in FIG. 1, the flow pathways through reformer units provided in the fuel cell stack and past the anodes of the fuel cells being shown;

FIG. 3 shows a schematic view of a fuel cell from the front side of the fuel cell stack shown in FIG. 1, the flow pathways through reformer units provided in the fuel cell stack and past the anodes of the fuel cells being shown; and

FIG. 4 shows a perspective view of a gas hood having integrated hollow profiles for the supply and discharge of gases.

### DETAILED DESCRIPTION OF THE INVENTION

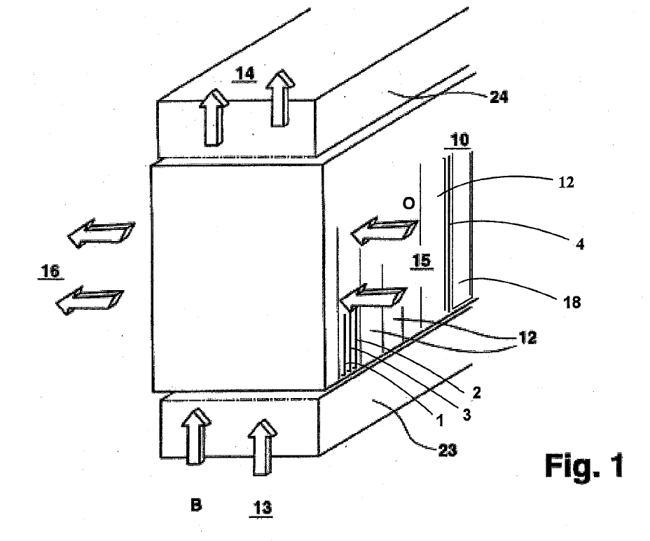

The fuel cell stack, which is schematically shown in FIG. 1 in a partial perspective view and is designated as a whole by the reference numeral 10, contains a number of fuel cells 12. The fuel cells 12 each contain, as is only schematically indicated in FIG. 1, an anode 1, a cathode 2, and an electrolyte matrix 3 situated between them. Furthermore, reformer units 18, which are formed by plate-shaped elements, are provided in the fuel cell stack 10. The reformer units 18 may be situated at the end of the fuel cell stack 10 or in particular between two adjacent fuel cells 12. Multiple fuel cells 12 may be combined into a group in each case and the reformer units 18 may be situated on one or between two adjacent groups of fuel cells 12. In the case of adjacent fuel cells which are separated from one another by reformer units 18, the bipolar plates 4 may also form components of the reformer units 18 or be contained therein. The bipolar plates 4 are used for the purpose of leading the flows of a combustion gas B and a cathode gas or oxidation gas O separately from one another over the anode 1 or over the cathode 2, respectively, of particular fuel cells. The electrical contact to the anode 1 and to the cathode 2 is produced by current collectors situated on these electrodes in each case, which are not separately shown in FIG. 1.

In the exemplary embodiment shown in FIG. 1, the flow of the combustion gas B and that of the cathode gas O permeate the fuel cell stack 10 transversely to one another, i.e., like a cross-flow. An anode intake 13 is used for the feed of fresh combustion gas B to the anodes 1 and an anode outlet 14 is used for the discharge of consumed combustion gas B therefrom. A cathode intake 15 is used for the feed of fresh cathode gas or oxidation gas O to the cathodes 2 and finally a cathode outlet 16 is used for the discharge of consumed cathode gas O therefrom.

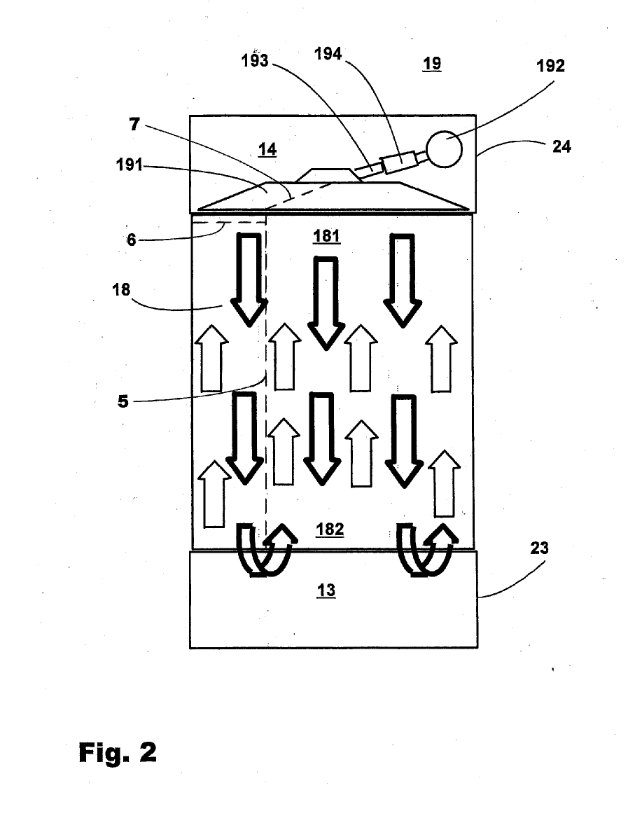

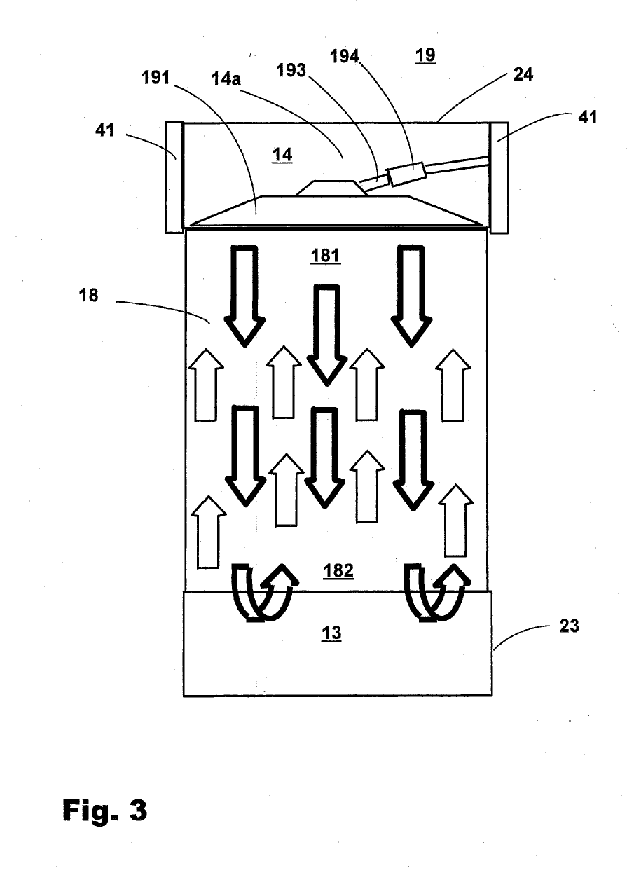

FIGS. 2 and 3 show a section in each case through a reformer unit 18 transversely to the longitudinal direction of the fuel cell stack 10 and in particular show the gas flow pathways through the reformer units 18 and the gas flow pathways along the anodes 1, the gas flow pathways through the reformer units 18 being shown by bold arrows and the gas flow pathways at the anodes 1 being shown by thin arrows.

Fuel to be reformed is fed to the reformer units 18 at a fuel inlet 181 and this fuel is discharged to a reformer fuel outlet 182 after its conversion. During the reforming of the fuel, which is an endothermic procedure, heat is withdrawn from the adjacent fuel cell or fuel cells 12 inside the fuel cell stack 10 because of the circumstance that the reformer units 18 are in thermal contact therewith, and cooling thereof is thus caused.

The outlet 182 of the reformer units 18, at which the reformed fuel is discharged, is located on the side of the fuel cell stack 10 on which the anode intake 13 of the fuel cells 12 is also located. This means that the reformed fuel discharged from the reformer units 18 is available to the anodes 1 as combustion gas at their intake 13. In contrast, the fuel inlets 181 of the reformer units 18 are provided on the side of the fuel cell stack 10 opposite to the anode intake 13, so that the flow direction of the fuel to be reformed (arrows shown using bold lines) through the reformer units 18 forms a counter-flow to the main flow direction of the combustion gas B (arrows shown using thin lines) at the anodes 1. As may be seen from FIGS. 2 and 3, a uniformly distributed counter-flow in relation to the flow at the anodes 1 occurs through the reformer units 18, which is distributed essentially uniformly over the entire area of the reformer units 18. A more uniform heat transfer from the anodes 1 to the reformer units 18 thus occurs in the meaning of uniform cooling of the fuel cell stack over essentially its entire cross-sectional area.

In the case that the cathode gas at lower temperature guided in cross-flow to the fuel flow enters the cathode intake, it can be desirable to reduce the fuel flow in the cathode intake area in order to prevent the reforming and the cooling accompanying it. This can be implemented using the device according to the invention by simple measures in that the fuel flow is variably adaptable, as described in greater detail hereafter.

As may be seen from FIGS. 2 and 3, a fuel discharge system, which is identified as a whole by the reference numeral 19, is provided on the side of the fuel inlets 181 of the reformer units 18, which is used for distributing the fuel to be reformed to the individual reformer units 18.

In the exemplary embodiments shown, the fuel discharge system 19 comprises fuel feeds 191 connected to the fuel inlets 181 of each reformer unit 18, using which the fed fuel to be reformed is distributed uniformly over the entire width of the reformer units 18, and a distributor line 192, which is connected to each of these fuel feeds 191 (FIG. 2), and/or a channel 41, which is connected to each of these fuel feeds 191 (FIG. 3). The distributor line 192 and/or the channel 41 are connected via intermediate lines 193 to each of the fuel feeds 191. The intermediate lines 193 each contain a dielectric partition element 194, which causes electrical insulation of the reformer units 18 from the distributor line 192 and/or from the channel 41.

It is possible to optimize the cooling in the stack through the flow guiding of the fuel to be reformed in the plane of the reformer units. As already described above, in the case of guiding of the cathode gas in cross-flow to the fuel, the temperature in the area of the cathode intake is lower than in the area of the cathode outlet. In order to prevent excessively strong cooling by the reforming procedure in the areas adjacent to the cathode intake area, it is easily possible to reduce the fuel flow in the corresponding areas of the reformer units or, by partitioning off corresponding areas, to entirely avoid it, in that areas (20 to 100% of the maximum possible width) of the reformer units are removed from the overlap of the fuel feeds 191 connected to the reformer units. The areas of the reformer units removed by the fuel feeds 191 are provided with covers 6 for this purpose and the fuel entry therein is thus prevented. In order to remove the corresponding areas of the reformer units on the cathode intake side entirely from the permeation with fuel, walls 5 running parallel to the flow direction may be provided in the reformer units for the partitioning. Corresponding covers 7 and/or walls 5 and a fuel supply 191, which is reduced in width and is delimited by a line 7, are indicated in FIG. 2 by interrupted lines. Alternatively or additionally, positioning catalyst material can be dispensed with in the corresponding areas on the cathode intake side.

In the exemplary embodiments shown in FIGS. 2 and 3, a gas hood 24 is provided on the side of the fuel cell stack 10 opposite to the anode intakes 13, which is used for receiving the consumed combustion gas discharged from the anode outlets 14 and in which the fuel discharge system 19 is situated. A similar gas hood 23 is provided on the side of the anode intakes 13, which is used for the feed of the reformed combustion gas to the anode intakes 13.

In the exemplary embodiment shown in FIG. 2, the gas hood 24 delimits a chamber which receives consumed combustion gas discharged from the anode outlets 14, in which the fuel feeds 191, which are connected to the fuel intakes 181 of each reformer unit 18, and the distributor line 192 connected thereto and the intermediate lines 193, which each contain the described dielectric partition element 194, are situated.

In the exemplary embodiment shown in FIG. 3, the gas hood 24 again delimits a chamber which receives the consumed combustion gas discharged from the anode outlets 14, in which the fuel feeds 191 connected to each of the fuel inlets 181 of the reformers 18 are situated, but the gas hood 24 is additionally implemented so that it contains a first gas guiding pathway 14a, which forms the chamber used for receiving the consumed combustion gas from the anode outlets 14, and one or more gas guiding channels 41, which are sealed in relation to the described first gas guiding pathway 14a and are connected to the fuel feeds 191, and which are provided for discharging the fuel to be reformed to the fuel feeds 191. The gas guiding channels 41 are connected to the fuel feeds 191 via the described intermediate lines 193, which each contain the described dielectric partition element 194.

The gas guiding channel or channels 41 are situated in the exemplary embodiment shown in FIG. 3 on the longitudinal side of the gas hood 24 in the form of a frame tube thereof, which extends on both longitudinal sides thereof.

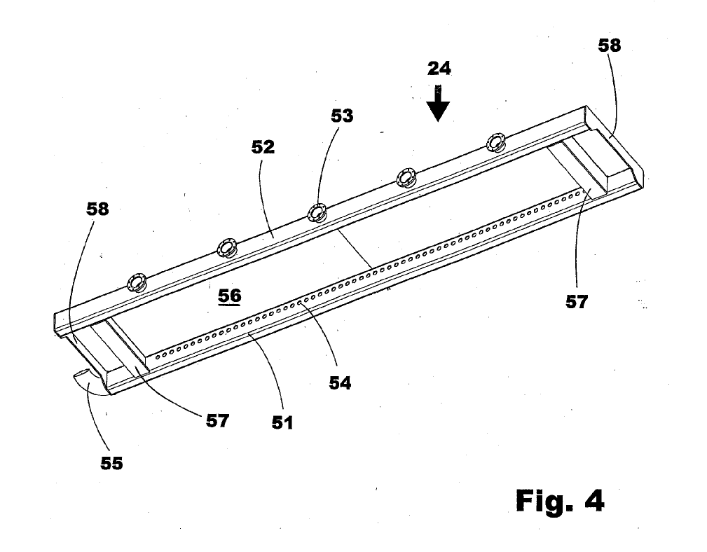

FIG. 4 shows a gas hood 24 of this type implemented having hollow profiles 51 and 52 in greater detail. The hollow profiles 51 and 52, which comprise rectangular tubes, form the gas hood 24 in a composite with plates 56, 58 and crossbeams 57, the hollow profiles 51 and 52 forming the lateral parts, but also being used for the supply and discharge of gases. The hollow profile 51 is used for the transfer of the fuel into the fuel feeds 191. For this purpose, holes 54 are provided on the inner sides of the hollow profile 51, to which the intermediate lines 193 are attached. A fitting 55 is used to introduce the fuel from an external source into the hollow profile 51. The hollow profile 52 opposite to the hollow profile 51 on the other side of the gas hood 24 is used for discharging the anode exhaust gas flowing out of the anodes. For this purpose, holes (not shown) are provided on the inner side of the hollow profile 52, which connect the cavity of the hollow profile 52 to the inner chamber of the gas hood 24, which is connected to the anode outlets 14. The exhaust of the anode exhaust gas collected in the hollow profile 52 finally occurs via connecting pieces 53 on the outer side of the hollow profile 52. The holes and connecting pieces are distributed over the length and their cross-section is designed so that a uniform flow is achieved over the fuel cell stack. The gas hood 24 in the described implementation is to be produced as a welded structure made of few components, for example. Because parts of the gas hood are also used as media guides, a multifunctional component results, which is simple and comprehensible in construction in spite of complex functionality. The configuration of the hollow profile 51 on the outer edge of the gas hood 24 also has the advantage that because of the spacing of the connection points, the intermediate lines 193 may be implemented having correspondingly greater length. Unavoidable relative shifts between stack and gas hood 24 result in small introductions of force as a result of the small lever arm, so that the danger of leakage is reduced.

In the described exemplary embodiments, the reformer units 18 are formed by plate-shaped elements, which are situated parallel to the fuel cells 12, and may contain a material of a reformer catalyst in a configuration and way known per se. In particular, the material of the reformer catalyst can be situated in gas flow pathways which are defined by the described plate-shaped elements.

As already noted at the beginning, the reformer units 18 may contain bipolar plates 4, by which adjacent fuel cells 12 are delimited to one another and electrically contacted in each case. In particular, the bipolar plates 4 may delimit the gas flow pathways in the reformer units 18 to one of the adjacent fuel cells 12. Electrical contracting of the bipolar plates 4 can be performed in a way known per se by suitable current collectors.

1. A fuel cell configuration having fuel cells arranged in the form of a fuel cell stack, each stack contains an anode and a cathode and an electrolyte matrix situated between them, having an anode intake, which is provided on one side of the fuel cell stack, for the feed of fresh combustion gas to the an anode and an anode outlet for the discharge of consumed combustion gas from the anode, gas flow pathways being provided inside the fuel cells, in order to guide the combustion gas in a predetermined main flow direction past the anodes, having reformer units for converting a fuel supplied to the reformer units at a fuel inlet into reformer fuel, which is discharged from the reformer units at a reformer fuel outlet, the reformer units being situated between adjacent fuel cells in thermal contact therewith inside the fuel cell stack, and the reformer fuel outlet of the reformer units opening on the side of the fuel cell stack, on which the anode intake of the fuel cells is located, and having a fuel discharge system for distributing the fuel to be reformed to the individual reformer units, characterized in that the fuel inlets of the reformer units are provided on the side of the fuel cell stack opposite to the anode intake and the reformer units are permeated by the fuel to be reformed in counter-flow to the main flow direction of the combustion gas in the gas flow pathways leading past the anodes, and the fuel discharge system provided for distributing the fuel to be reformed is provided on the side of the fuel cell stack opposite to the anode intake.

2. The fuel cell configuration according to claim 1,
characterized in that the fuel discharge system contains fuel feeds connected to each of the fuel inlets of each reformer unit.

3. The fuel cell configuration according to claim 2,
characterized in that no catalyst material is placed in the areas of the reformer units close to the cathode intake in the case of the fuel guided in cross-flow to the cathode gas.

4. The fuel cell configuration according to claim 2,
characterized in that the fuel flow guided in proximity to the cathode intake through the reformer units is reduced by areas removed from the fuel feeds and replaced by covers.

5. The fuel cell configuration according to claim 4,
characterized in that the areas of the reformer units removed from the fuel feeds are partitioned in relation to the areas overlapped by the fuel feeds against fuel supply by walls inside the reformer units.

6. The fuel cell configuration according to one of claim 1,
characterized in that a gas hood, which is used to receive the consumed combustion gas discharged from the anode outlets, is provided on the side of the fuel cell stack opposite to the anode intakes, where the fuel discharge system is also located.

7. The fuel cell configuration according to claim 6,
characterized in that the gas hood delimits a chamber, which receives the consumed combustion gas discharged from the anode outlets, in which the fuel feeds connected to each of the fuel inlets of each reformer unit and a distributor line connected to each of the fuel feeds are also situated.

8. The fuel cell configuration according to claim 7,
characterized in that the distributor line is connected to the fuel feeds via intermediate lines in each case, which each contain a dielectric partition element for the electrical insulation of the reformer units from the distributor line.

9. The fuel cell configuration according to claim 6,
characterized in that the gas hood delimits a chamber which receives the consumed combustion gas discharged from the anode outlets, in which fuel feeds connected to each of the fuel inlets of each reformer unit are situated, and the gas hood contains a first gas guiding pathway, which forms a chamber used to receive the consumed combustion gas from the anode outlets, and, sealed thereto and connected to the combustion gas supplies, at least one gas guiding channel for the discharge of fuel to the fuel feeds.

10. The fuel cell configuration according to claim 9,
characterized in that the gas guiding channel is connected to the fuel feeds via intermediate lines in each case, which each contain a dielectric partition element for the electrical insulation of the reformer units from the distributor line.

11. The fuel cell configuration according to claim,
characterized in that the gas guiding channel is formed by at least one hollow profile, running on one longitudinal side of the gas hood, having holes for the discharge of the fuel.

12. The fuel cell configuration according to claim 11,
characterized in that hollow profiles are situated on both longitudinal sides of the gas hood.

13. The fuel cell configuration according to claim 12,
characterized in that the gas hood is a composite made of plates and crossbeams, in which the hollow profiles are integrated as lateral parts of the gas hood.

14. The fuel cell configuration according to claim 12,
characterized in that one of the hollow profiles has openings for the discharge of the anode exhaust gas exiting from the anode outlet into the chamber delimited by the gas hood.

15. The fuel cell configuration according to claim 14,
characterized in that the hollow profile is implemented having holes on its inner side, via which the anode exhaust gas enters the hollow profile, and the hollow profile is provided with connecting pieces on its outer side, at which the anode exhaust gas can be discharged outward.

16. The fuel cell configuration according to one of claim 1,
characterized in that the reformer units are formed by plate-shaped elements situated parallel to the fuel cells, which each define gas flow pathways, which are exclusively permeated in counter-flow to the main flow direction of the reformed combustion gas in the gas flow pathways leading past the anodes.

17. The fuel cell configuration according to claim 16,
characterized in that the gas flow pathways defined by the plate-shaped elements contain a material of a reformer catalyst.

18. The fuel cell configuration according to claim 16,
characterized in that the reformer units contain bipolar plates, by which adjacent fuel cells of the fuel cell stack are delimited from one another and are electrically contacted.

19. The fuel cell configuration according to claim 18,
characterized in that the bipolar plates delimit the gas flow pathways in the reformer units toward one of the adjacent fuel cells.
